(19) United States
(12) Patent Application Publication
(10) Pub. No.: US 2021/0368889 A1
(43) Pub. Date: Dec. 2, 2021

(54) FACEMASK INCLUDING A SILANE QUATERNARY AMMONIUM ION OR SALT THEREOF DISPOSED ON THE EXPOSED SURFACE AND A METHOD OF TREATING A FACEMASK TO IMPART ANTIMICROBIAL PROPERTIES TO THE EXPOSED SURFACE

(71) Applicant: Parasol Medical, LLC, Buffalo Grove, IL (US)

(72) Inventor: Patrick E. Eddy, Allendale, MI (US)

(73) Assignee: Parasol Medical, LLC, Buffalo Grove, IL (US)

(21) Appl. No.: 16/885,983

(22) Filed: May 28, 2020

(51) Int. Cl. A41D 13/11; A01N 55/00; A01N 59/00

(52) U.S. Cl. CPC A41D 13/1192; A01N 59/00; A01N 55/00; A41D 13/1161

(57) ABSTRACT

A facemask with an exposed surface, and a silane quaternary ammonium ion or salt thereof disposed on the exposed surface. The facemask further can have a main body portion, and one or more straps extending from the main body portion. The silane quaternary ammonium ion or salt thereof is disposed on the main body and on the straps. The main body portion can include a convex side and a concave side. The silane quaternary ammonium ion or salt thereof can be further disposed on the convex side and the concave side. The silane quaternary ammonium ion or salt thereof can be one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, and 3-(trihydroxysilyl)propyldimethyloctadecyl ammonium chloride. A solution including the silane quaternary ammonium ion or salt thereof can be applied to the exposed surface. The solution can further include water, isopropyl alcohol, and hydrogen peroxide or hypochlorous acid.

### BACKGROUND OF THE INVENTION

A person infected with a virus can spread the virus to another person. For example, the infected person can spread the virus by expelling droplets that contain the virus, which then enter the mouth or nose of the other person. The infected person can expel droplets via sneezing, coughing, or talking, among other ways. The virus entering the mouth or the nose of the other person can infect that other person with the virus. The virus then continues to spread to other people in a like manner.

Either the infected person or the other person can wear a facemask as a physical barrier between the infected person and the other person. The facemask can block the droplets containing the virus that the infected person expels from reaching the mouth or nose of the other person.

However, there is a problem in that the facemask can itself harbor the virus and thus potentially facilitate the spread of the virus from the infected person to the other person. To address this problem, manufacturers and institutions such as hospitals require the facemasks to be “single use” or otherwise disposable—requiring a constant supply of new facemasks. This strategy leads to additional problems such as shortages and rationing of facemasks. These consequential problems are especially harmful during a pandemic.

### SUMMARY OF THE INVENTION

The present disclosure solves the aforementioned problem, not by making the facemask “single use,” but by applying a silane quaternary ammonium ion or salt thereof to an exposed surface of the facemask. The silane quaternary ammonium ion or salt thereof bonds to the exposed surface of the facemask. If the droplet containing the virus contacts the silane quaternary ammonium ion or salt bonded to the exposed surface, then the silane quaternary ammonium ion or salt thereof can destroy the virus. Thus, the facemask no longer harbors the virus and the facemask can be utilized on a plurality of occasions. Even in the event that the facemask is still required to be “single use” or disposable, the silane quaternary ammonium ion or salt killing the virus reduces the likelihood that the virus can be transmitted to the wearer of the facemask or another person.

In a first aspect of the disclosure, a facemask comprises: an exposed surface; and a silane quaternary ammonium ion or salt thereof disposed on the exposed surface. In embodiments, the facemask further comprises a main body portion; and one or more straps extending from the main body portion. In embodiments, the silane quaternary ammonium ion or salt thereof is disposed on the main body. In embodiments, the silane quaternary ammonium ion or salt thereof is further disposed on the straps. In embodiments, the main body portion further includes a convex side and a concave side. In embodiments, the silane quaternary ammonium ion or salt thereof is further disposed on the convex side. In embodiments, the silane quaternary ammonium ion or salt thereof is further disposed on the concave side. In embodiments, the main body portion further comprises a non-woven fabric. In embodiments, the silane quaternary ammonium ion or salt thereof is disposed on the woven fabric. In embodiments, the main body portion further comprises a plurality of folds. In embodiments, the silane quaternary ammonium ion or salt thereof is disposed on the plurality of folds. In embodiments, the facemask blocks at least 95 percent of particles having a mass median aerodynamic diameter of 0.3 μm. In embodiments, the main body portion further comprises an exposed metal strip. In embodiments, the silane quaternary ammonium ion or salt thereof is disposed on the exposed metal strip. In embodiments, the silane quaternary ammonium ion or salt thereof is one or more of: 3-(trimethoxysilyl)propyldimethyloctadecyl ammonium ion, 3-(trimethoxysilyl)propyldimethyloctadecyl ammonium chloride, 3-(trihydroxysilyl)propyldimethyloctadecyl ammonium ion, and 3-(trihydroxysilyl)propyldimethyloctadecyl ammonium chloride.

In a second aspect of the disclosure, a method of treating a facemask comprises: applying a solution comprising a silane quaternary ammonium ion or salt thereof to an exposed surface of a facemask. In embodiments, the solution further comprises water. In embodiments, the solution further comprises isopropyl alcohol. In embodiments, the solution further comprises hydrogen peroxide. In embodiments, the solution further comprises hypochlorous acid. In embodiments, applying the solution comprises spraying the solution onto the exposed surface of the facemask. In embodiments, an electrostatic sprayer is utilized to spray the solution. In embodiments, the exposed surface to which the solution is applied is at a main body portion of the facemask. In embodiments, the exposed surface to which the solution is applied is at a strap of the facemask. In embodiments, the exposed surface to which the solution is applied is at a convex portion of the main body portion of the facemask. In embodiments, the exposed surface to which the solution is applied is at least one of: (i) a concave portion of the main body portion of the facemask; (ii) a non-woven fabric that forms part of the main body portion; (iii) a plurality of folds; and (iv) an exposed metal strip disposed at the main body portion.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a facemask, illustrating exposed surfaces at a main body portion and straps extending from the main body portion, the exposed surfaces including a silane quaternary ammonium ion or salt thereof disposed thereupon to impart antimicrobial (including antiviral) properties to the facemask;

FIG. 2 is another perspective view of the facemask of FIG. 1, illustrating a concave side and a plurality of folds, each having exposed surfaces;

FIG. 3 is an elevation view of a cross-section of the facemask of FIG. 1 taken along line III-III of FIG. 2, illustrating the main body portion including a plurality of layers;

FIG. 4 is a perspective view of a person wearing the facemask of FIG. 1, illustrating the facemask covering a mouth and a nose of the person;

FIG. 5 is a perspective view of another embodiment facemask, illustrating a metal strip disposed on a convex side of the main body portion of the facemask, and the exposed surfaces including a silane quaternary ammonium ion or salt thereof disposed thereupon to impart antimicrobial (including antiviral) properties to the facemask; and

FIG. 6 is schematic flow chart of a method of treating the facemask of either FIG. 1 or FIG. 5 (or both) to impart antimicrobial (including antiviral) properties to the facemask, illustrating a step of applying a solution comprising the silane quaternary ammonium ion or salt thereof to the exposed surface of the facemask.

### DETAILED DESCRIPTION

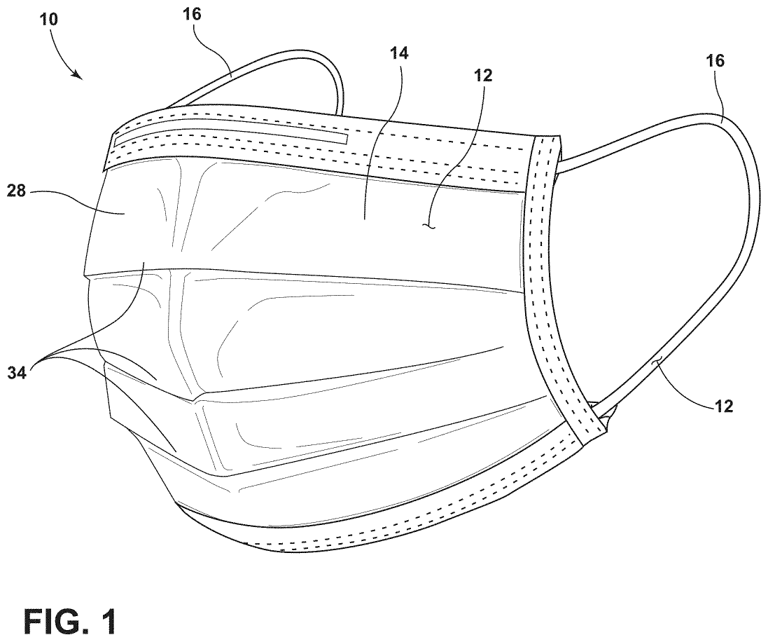

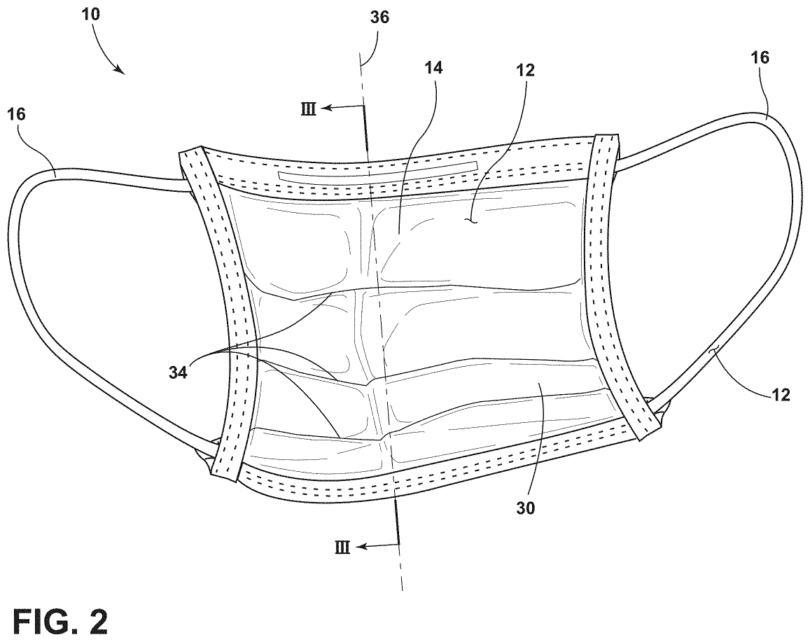

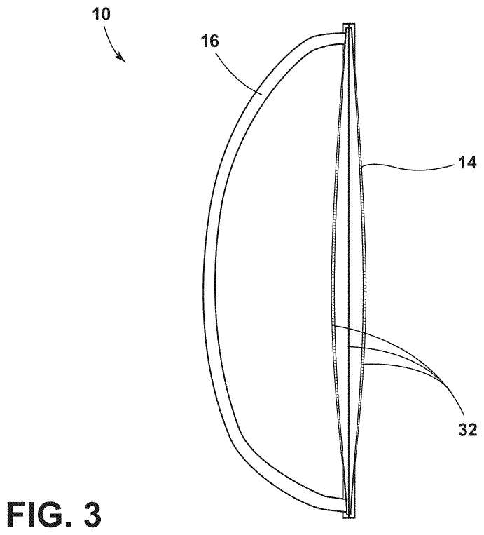

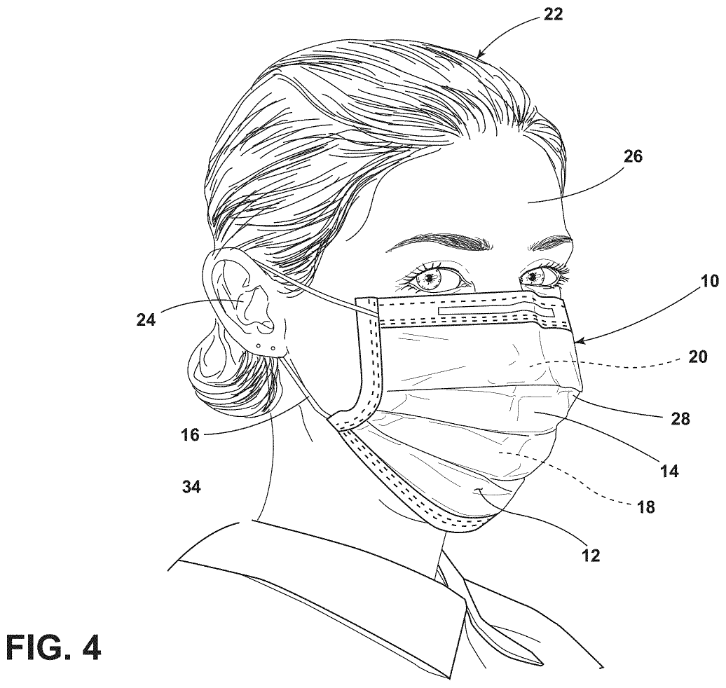

Referring now to FIGS. 1-4, a facemask 10 is illustrated. The facemask 10 includes an exposed surface 12. The exposed surface 12 is any portion of the facemask 10 open to the external environment. A silane quaternary ammonium ion or salt thereof is disposed on the exposed surface 12. The silane quaternary ammonium ion or salt thereof in some embodiments is chemically bonded to the exposed surface 12. In other embodiments, the silane quaternary ammonium ion or salt thereof is directly or indirectly physically bonded to the exposed surface 12. In embodiments, the facemask 10 is designated as a surgical mask or a respirator, among other things. In embodiments, the facemask 10 is designated as single-use, disposable, or reusable. In embodiments, the facemask 10 meets an applicable standard to be marketed as an “N95” respirator. In embodiments, the facemask 10 blocks at least 95 percent of particles having a mass median aerodynamic diameter of 0.3 μm.

In embodiments, the facemask 10 includes a main body portion 14 and one or more straps 16 extending from the main body portion 14. In use, the main body portion 14 covers a mouth 18 and a nose 20 of a person 22 wearing the facemask 10. The one or more straps 16 are utilized to secure the facemask 10 to the person 22, such as looping around an ear 24 of the person 22 or around a head 26 of the person 22. The exposed surface 12 can be disposed at the main body portion 14, the one or more straps 16, or both. In other words, in embodiments, the silane quaternary ammonium ion or salt thereof is disposed on the main body portion 14, the one or more straps 16, or both.

In embodiments, the main body portion 14 has a convex side 28 and a concave side 30. In use, the concave side 30 faces the mouth 18 and nose 20 of the person 22 wearing the facemask 10, while the convex side 28 faces away from the mouth 18 and nose 20 of the person 22. The main body portion 14 can be formed so that the main body portion 14 has the convex side 28 and the concave side 30 when the person 22 is not wearing the facemask 10. In other embodiments, the main body portion 14 is generally flat and develops a convex side 28 and a concave side 30 when the person 22 wears the facemask 10. The exposed surface 12 can be disposed at the convex side 28, the concave side 30, or both the convex side 28 and the concave side 30 of the main body portion 14 of the facemask 10. In other words, in embodiments, the silane quaternary ammonium ion or salt thereof is disposed on the convex side 28, the concave side 30, or both convex side 28 and the concave side 30 of the main body portion 14 of the facemask 10.

In embodiments, the main body portion 14 comprises a plurality of layers 32. Each layer of the plurality of layers 32 can be made of non-woven fabric, woven fabric, or filtering material. The plurality of layers 32 can include layers made of differing types of material—for example, one layer can be made of woven fabric while another layer is made of a filtering material. The exposed surface 12 can be disposed at the non-woven fabric, the woven fabric, or the filtering material, or a combination thereof. In other words, in embodiments, the silane quaternary ammonium ion or salt thereof is disposed on the non-woven fabric, the woven fabric, the filtering material, or a combination thereof, of the main body portion 14 of the facemask 10.

In embodiments, the main body portion 14 comprises a plurality of folds 34. The plurality of folds 34 allow the main body of the mask to be pulled in opposing directions at a centerline 36 of the facemask 10 so that the facemask 10 can elongate along the centerline 36 to cover the nose 20 and mouth 18 of the person 22 wearing the facemask 10 while narrowing toward the one or more straps 16. The exposed surface 12 can be at the plurality of folds 34. In other words, in embodiments, the silane quaternary ammonium ion or salt thereof is disposed on the plurality of folds 34 of the main body portion 14 of the facemask 10.

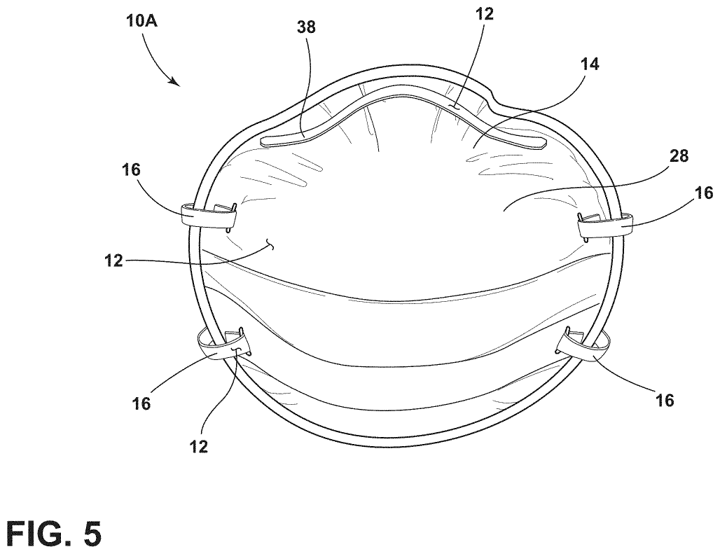

Referring now to FIG. 5, another embodiment facemask 10A is illustrated, and like numbers between facemask 10 and facemask 10A refer to like elements, without the need to restate each element herein. The facemask 10A further comprises an exposed metal strip 38. The metal strip 38 can be utilized to contour the main body portion 14 of the facemask 10 over the nose 20 of the person 22. The exposed surface 12 can be at the metal strip 38. In other words, in embodiments, the silane quaternary ammonium ion or salt thereof is disposed on the exposed metal strip 38.

The silane quaternary ammonium ion or salt thereof expresses antiviral activity against a variety of viruses. In the event that the droplet including the virus lands on the exposed surface 12 of the facemask 10, the silane quaternary ammonium ion or salt thereof can destroy the virus. Destroying the virus reduces the likelihood that the person 22 wearing the facemask 10, 10A or some other person will become infected with the virus. The silane quaternary ammonium ion or salt thereof additionally expresses antibacterial activity against a variety of bacteria. Without being bound by theory, it is thought that the silane quaternary ammonium moiety chemically bonds to the exposed surface 12 of the facemask, providing long-lasting antiviral properties to the facemask 10, 10A.

In embodiments, the silane quaternary ammonium ion or salt thereof is one or more of:

3-(trimethoxysilyl)propyldimethyloctadecyl ammonium ion,

3-(trimethoxysilyl)propyldimethyloctadecyl ammonium chloride,

3-(trihydroxysilyl)propyldimethyloctadecyl ammonium ion, and

3-(trihydroxysilyl)propyldimethyloctadecyl ammonium chloride.

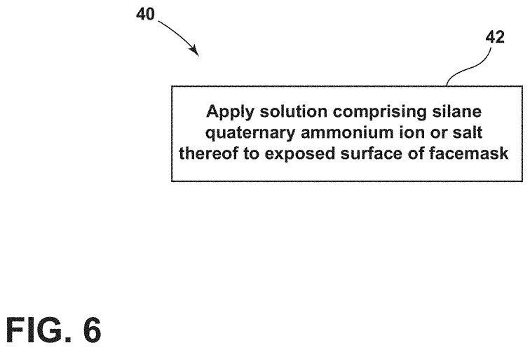

Referring now to FIG. 6, a method 40 of treating a facemask 10 to impart anti-microbial (including anti-viral) properties to the facemask 10 is schematically illustrated. The method 40 comprises, at a step 42, applying a solution comprising the silane quaternary ammonium ion or salt thereof to the exposed surface 12 of the facemask 10. The exposed surface 12 can be at the main body portion 14, the one or more straps 16, the convex portion, the concave portion, non-woven fabric, the plurality of folds 34, the exposed metal strip 38, or any other of the previously mentioned locations, or any combination thereof. That list is not exclusive and the exposed surface 12 to which the solution is applied can be any surface of the facemask 10, 10A that is exposed to the external environment.

The solution includes a liquid component that carries the silane quaternary ammonium ion or salt to the exposed surface 12, allowing the silane quaternary ammonium ion or salt to bond to the exposed surface 12. The liquid component dries off leaving the silane quaternary ammonium ion or salt to be bonded to the exposed surface 12. The silane quaternary ammonium ion or salt thereof is not necessarily known for quick acting microbial reduction like a disinfectant. However, the silane quaternary ammonium ion or salt thereof provides residual long-lasting antimicrobial activity that is not consumed while destroying the virus or other microbe. In embodiments, the silane quaternary ammonium ion or salt thereof is between 0.1 percent and 10 percent by weight of the solution.

In embodiments, the solution further comprises water as the liquid component. In embodiments, the solution further comprises isopropyl alcohol as the liquid component (solvent). In embodiments, the isopropyl alcohol is between 30 percent to 90 percent by weight of the solution. In embodiments, the solution includes both water and isopropyl alcohol. An example solution comprises (by weight) 60.0 percent isopropyl alcohol, 2.02 percent 3-(trimethoxysilyl)propyldimethyloctadecyl ammonium chloride, and 34.19 percent deionized water.

In embodiments, the solution further comprises hydrogen peroxide. In embodiments, the hydrogen peroxide is 0.05 percent by weight to 7.5 percent by weight of the solution. The hydrogen peroxide operates as a disinfectant, which compliments the long-lasting antimicrobial properties of the silane quaternary ammonium ion or salt.

In embodiments, the solution further comprises hypochlorous acid. In embodiments, the solution comprises hypochlorous acid, a silane quaternary ammonium ion or salt thereof, and water. In embodiments, the hypochlorous acid exists in the solution at a concentration of 0.1 to 1000 ppm. In embodiments, the hypochlorous acid exists in the solution at a concentration of 0.1 to 200 ppm. In embodiments, the hypochlorous acid exists in the solution at a concentration of 200 to 1000 ppm. The hypochlorous acid operates as a disinfectant, which compliments the long-lasting antimicrobial properties of the silane quaternary ammonium ion or salt.

In embodiments, the step 42 of applying the solution comprises spraying the solution onto the exposed surface 12 of the facemask 10, 10A. In such embodiments, the electrostatic sprayer is utilized to spray the solution. In other embodiments, the step 42 of applying the solution comprises dipping the facemask 10, 10A into a container that contains the solution. In other embodiments, the step 42 of applying the solution comprises wiping the exposed surface 12 of the facemask 10, 10A with a wipe that is soaked in the solution. The wipe transfers the solution from the wipe to the exposed surface 12 of the facemask 10, 10A.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A facemask comprising:
an exposed surface; and
a silane quaternary ammonium ion or salt thereof disposed on the exposed surface.

2. The facemask of claim 1 further comprising:
a main body portion; and
one or more straps extending from the main body portion;
wherein, the silane quaternary ammonium ion or salt thereof is disposed on the main body.

3. The facemask of claim 2, wherein
the silane quaternary ammonium ion or salt thereof is further disposed on the straps.

4. The facemask of claim 2, wherein
the main body portion further includes a convex side and a concave side; and
the silane quaternary ammonium ion or salt thereof is further disposed on the convex side.

5. The facemask of claim 2, wherein
the main body portion further includes a convex side and a concave side; and
the silane quaternary ammonium ion or salt thereof is further disposed on the concave side.

6. The facemask of claim 2, wherein
the main body portion further comprises a non-woven fabric; and
the silane quaternary ammonium ion or salt thereof is disposed on the woven fabric.

7. The facemask of claim 2, wherein
the main body portion further comprises a plurality of folds; and
the silane quaternary ammonium ion or salt thereof is disposed on the plurality of folds.

8. The facemask of claim 2, wherein
the facemask blocks at least 95 percent of particles having a mass median aerodynamic diameter of 0.3 μm.

9. The facemask of claim 2, wherein,
the main body portion further comprises an exposed metal strip; and
the silane quaternary ammonium ion or salt thereof is disposed on the exposed metal strip.

10. The facemask of claim 1, wherein the silane quaternary ammonium ion or salt thereof is one or more of:
3-(trimethoxysilyl)propyldimethyloctadecyl ammonium ion,
3-(trimethoxysilyl)propyldimethyloctadecyl ammonium chloride,
3-(trihydroxysilyl)propyldimethyloctadecyl ammonium ion, and
3-(trihydroxysilyl)propyldimethyloctadecyl ammonium chloride.

11. A method of treating a facemask comprising:
applying a solution comprising a silane quaternary ammonium ion or salt thereof to an exposed surface of a facemask.

12. The method of claim 11, wherein
the solution further comprises isopropyl alcohol.

13. The method of claim 11, wherein
the solution further comprises hydrogen peroxide.

14. The method of claim 11, wherein
the solution further comprises hypochlorous acid.

15. The method of claim 11, wherein
the solution further comprises water.

16. The method of claim 11, wherein
applying the solution comprises spraying the solution onto the exposed surface of the facemask.

17. The method of claim 16, wherein
an electrostatic sprayer is utilized to spray the solution.

18. The method of claim 11, wherein
the exposed surface to which the solution is applied is at a main body portion of the facemask.

19. The method of claim 11, wherein
the exposed surface to which the solution is applied is at a convex portion of the main body portion of the facemask.

20. The method of claim 11, wherein
the exposed surface to which the solution is applied is at least one of: (i) a concave portion of the main body portion of the facemask; (ii) a non-woven fabric that forms part of the main body portion; (iii) a plurality of folds; (iv) an exposed metal strip disposed at the main body portion; and (v) a strap of the facemask.
